(19) United States
(12) Patent Application Publication
(10) Pub. No.: US 2014/0146192 A1
(43) Pub. Date: May 29, 2014

(54) ACOUSTIC CONFIGURATION OF A WIRELESS CAMERA

(71) Applicant: OMNIVISION TECHNOLOGIES, INC., Santa Clara, CA (US)

(72) Inventors: Ting Zhou, Shanghai (CN); Shengqiang Yu, Shanghai (CN); Song'an Yang, Shanghai (CN); Tawei Ho, Cupertino, CA (US)

(73) Assignee: OMNIVISION TECHNOLOGIES, INC., Santa Clara, CA (US)

(21) Appl. No.: 13/685,487

(22) Filed: Nov. 26, 2012

(51) Int. Cl. H04N 5/232

(52) U.S. Cl. CPC H04N 5/23203
USPC 348/211.2

(57) ABSTRACT

An example wireless camera system includes a camera, a wireless network adapter, an acoustic receiver, and a processor. The camera is configured to acquire image data and the wireless network adapter wirelessly communicates the image data over a wireless network. The acoustic receiver is configured to receive an acoustic signal containing configuration data and the processor configures the network adapter to communicate over the wireless network using the received configuration data of the acoustic signal.

### TECHNICAL FIELD

This disclosure relates generally to wireless cameras, and in particular but not exclusively, relates to wireless cameras that lack a physical interface for wireless network configuration.

### BACKGROUND INFORMATION

Every network device that communicates on a wireless network requires at least some configuration information in order to pair with an access point on the network. In the case of an IEEE 802.11 wireless local area network (wireless LAN), the network device is typically required to know the service set identifier (SSID) of the wireless network and a password if encryption is implemented. In some instances, this configuration information must be manually entered by a user. Thus, a network device, such as a wireless camera, may include a physical interface for allowing the user to physically “plug-in” to the device to carry out the configuration by way of a software program on another device. In doing so, the network device is configured so that it may properly communicate on the wireless network. However, such techniques are often complex and the additional hardware is expensive to implement.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an arrangement for configuring a wireless camera system, in accordance with an embodiment of the invention.

FIG. 2 is a functional block diagram of a wireless camera system, in accordance with an embodiment of the invention.

FIG. 3 illustrates a user interface of a mobile station for configuring a network adapter of a wireless camera system, in accordance with an embodiment of the invention.

FIG. 4 is a flow diagram illustrating a process of configuring a network adapter of a wireless camera system, in accordance with an embodiment of the invention.

FIG. 5 illustrates a user interface of a mobile station for configuring a camera of a wireless camera system, in accordance with an embodiment of the invention.

FIG. 6 is a flow diagram illustrating a process of configuring a camera of wireless camera system, in accordance with an embodiment of the invention.

### DETAILED DESCRIPTION

Embodiments of a system and method for Acoustic Configuration of a Wireless Camera are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment”, “an embodiment,” or “an example” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In short, embodiments of the present invention include the configuration of a wireless camera system using acoustic signals locally generated by another device, such as a smartphone or tablet. In this way, some embodiments of the wireless camera system may not need the aforementioned physical interface for configuring the wireless camera system. These and other embodiments are described in detail below.

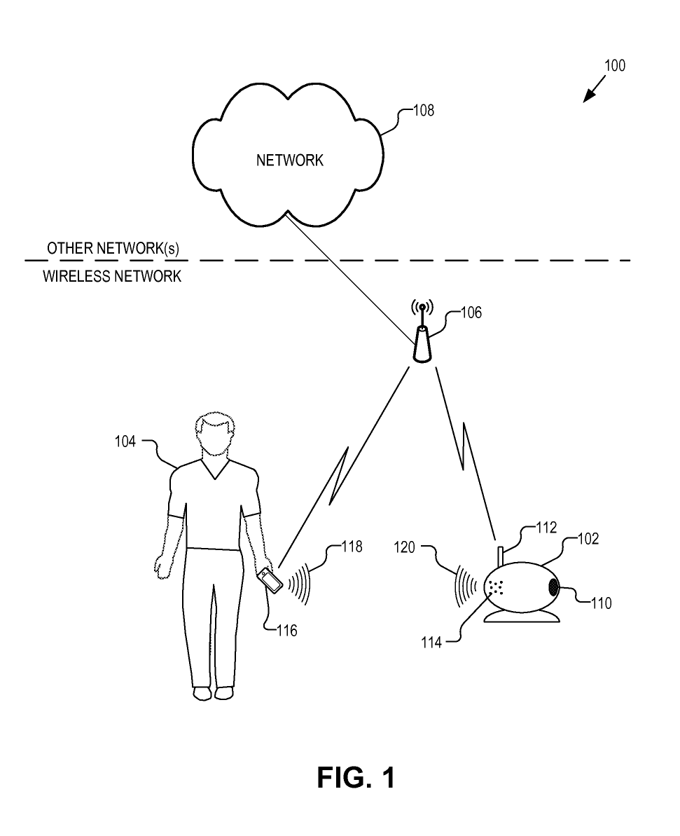

By way of example, FIG. 1 illustrates an arrangement 100 for configuring a wireless camera system 102 using acoustic signals 118, in accordance with an embodiment of the invention. The illustrated example of arrangement 100 includes wireless camera system 102, user 104, wireless access point 106, network 108, and mobile station 116. Wireless camera system 102 is shown as including a camera 110, an antenna 112, and speaker/microphone 114. Also shown in FIG. 1 are acoustic signals 118 and 120.

In operation, camera 110 is configured to acquire image data of a person, place, or object. A wireless network adapter (not shown in FIG. 1) included in the wireless camera system 102 then wirelessly communicates that image data, via antenna 112, over a wireless network. The illustrated embodiment of FIG. 1 illustrates a wireless network as including a wireless access point 106 connected to network 108. In one example, wireless access point 106 is a router that forwards data packets within the wireless network and also between the wireless network and network 108. In one example, network 108 is a wide area network, such as the internet.

In one embodiment, the acquired image data is communicated over the wireless network to be viewed on another computing device, such as mobile station 116. As used herein, a mobile station (MS) refers to a device such as a cellular or other wireless communication device, personal communication system (PCS) device, Personal Information Manager (PIM), Personal Digital Assistant (PDA), laptop, tablet or other suitable mobile device which is capable of sending and receiving acoustic (i.e., audio) signals. Although FIG. 1 illustrates mobile station 116 as being wirelessly connected to wireless access point 106, in other embodiments, mobile station 116 may be connected to another access point of the wireless network or may even be connected to another network, upstream from router 106, such as network 108.

Upon initial startup of the wireless camera system 102, the necessary configuration information may not be present in the camera system itself in order for it to communicate over the wireless network. Similarly, when deploying the wireless camera system 102 in a new wireless network, new configuration data may be needed. Thus, wireless camera system 102 must receive configuration data in order to communicate over the wireless network. However, in some instances, wireless camera system 102 does not include any physical interface that would allow user 104 to physically connect a computing device to transfer the configuration data. Nor does wireless camera system 102 include a display or user input interface (e.g., keypad) for entering configuration data directly into the camera system. Thus, as mentioned above, embodiments of the present disclosure provide for the transfer of configuration data using acoustic signals, such as acoustic signal 118 and acoustic acknowledgement signal 120.

To configure wireless camera system 102, user 104 may first start a software program running on the mobile station 116. In one embodiment, user 104 enters network configuration data, such as the SSID and/or password of the wireless network, via a user interface on the mobile station 116. Mobile station 116 then generates acoustic signal 118 containing the configuration data and transmits it via a speaker. Wireless camera system 102 then receives acoustic signal 118 via microphone/speaker 114 and in response generates an acoustic acknowledgement signal 120. In one embodiment, the configuration data is transferred between mobile station 116 and camera system 102 in segments, with the mobile station 116 waiting for the acoustic acknowledgement signal 120 before sending the next segment of the configuration data. Once the transfer of the configuration data is complete, wireless camera system 102 configures its wireless network adapter using the received configuration data.

The wireless network adapter of camera system 102 then pairs with wireless access point 106 for communicating over the wireless network. Once paired with wireless access point 106, further configuration data may be transferred to wireless camera system 102 via the wireless network. For example, software running on mobile station (or another computing device) may be configured to allow user 104 to further configure the network settings of the wireless camera system or may even allow user 104 to configure camera 110, itself. In one embodiment, the configuration of camera 110 may include setting various parameters of camera 110 such as the frame rate and resolution.

While in one embodiment, the configuration of camera 110 may be done by way of communicating configuration data over the wireless network, in another embodiment, configuration of camera 110 may be done by way of generating additional acoustic signals. That is, mobile device 116 may be configured to receive user input specifying various camera parameters (e.g., frame rate, resolution, etc.) and in response, generate acoustic signal 118 that includes this additional configuration data. The microphone 114 of wireless camera system 102 then detects the acoustic signal 118 and configures camera 110 using the received additional configuration data.

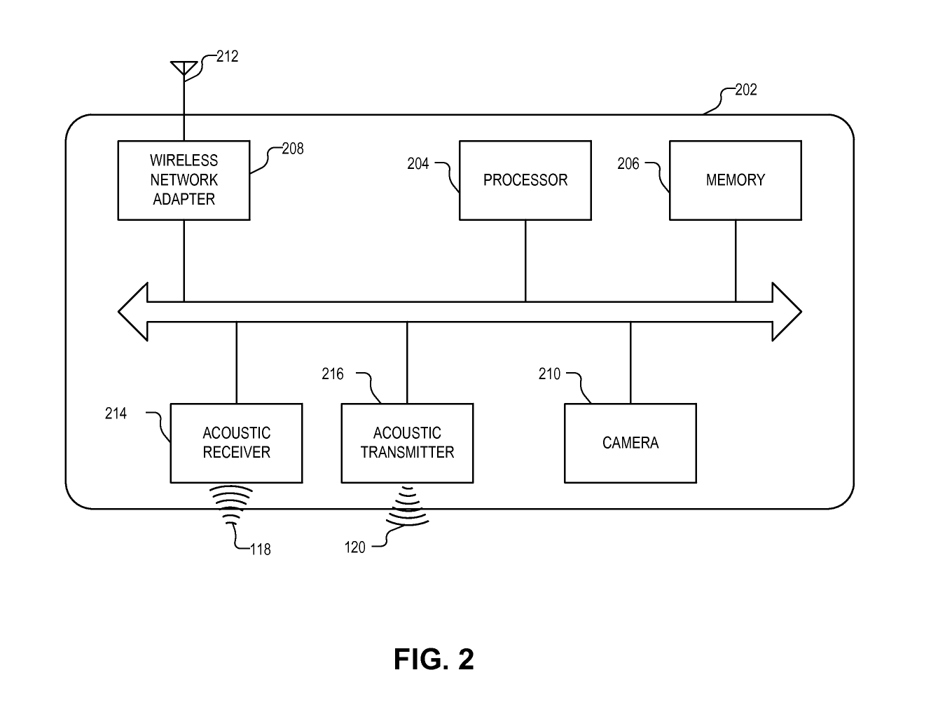

FIG. 2 is a functional block diagram of a wireless camera system 202, in accordance with an embodiment of the invention. Wireless camera system 202 is one possible implementation of wireless camera system 102 of FIG. 1. The illustrated example of wireless camera system 202 includes a processor 204, memory 206, a wireless network adapter 208, a camera 210, an antenna 212, an acoustic receiver 214, and an acoustic transmitter 216.

In one embodiment, camera 210 of wireless camera system 202 may include a complementary metal oxide semiconductor (CMOS) image sensor including the associated readout, control, and signal processing circuitry. Camera 210 is adapted to acquire image data of a person, place, or object and in some embodiments, includes associated optics, such as lenses.

Memory 206 includes any mechanism that provides (i.e., stores and/or transmits) information in a form accessible by processor 204. For example, memory 206 may include recordable/non-recordable media (e.g., read only memory (ROM), and random access memory (RAM), magnetic disk storage media, optical storage media, flash memory devices, etc.). In one embodiment, memory 206 includes instructions, that when executed by processor 204 will cause processor 204 to perform the operations described herein. Additionally, one or more of the processes described herein may be embodied within hardware, such as an application specific integrated circuit (ASIC) or the like.

Also shown in FIG. 2, is a wireless network adapter 208 with antenna 212 for wirelessly communicating over a wireless network. In one embodiment, wireless network adapter 208 is adapted for communicating over an IEEE 802.11 wireless network.

FIG. 2 further illustrates acoustic receiver 214 and acoustic transmitter 216. In one embodiment, acoustic receiver 214 includes a audio transducer such as a microphone. Similarly, acoustic transmitter 216 may include an audio transducer such as a speaker.

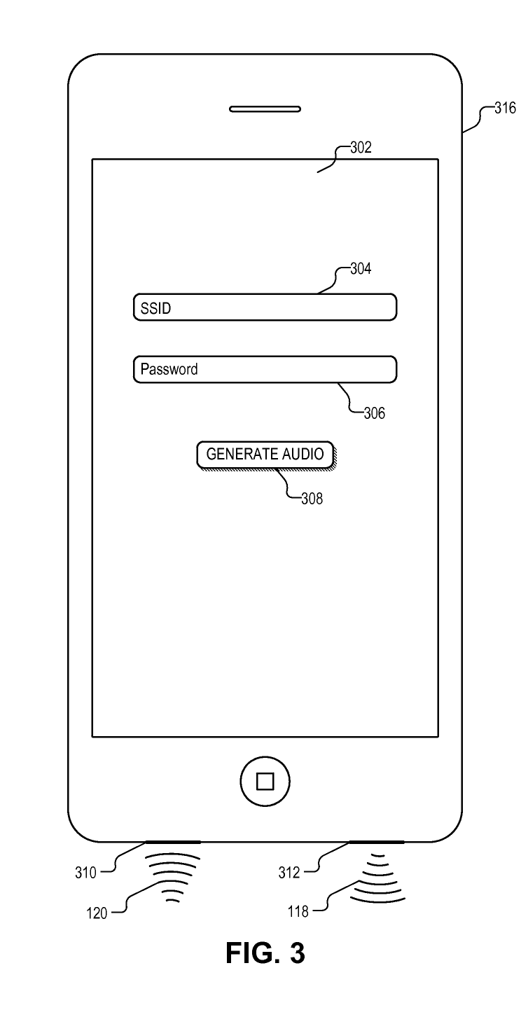

FIG. 3 illustrates a user interface 302 of a mobile station 316 for configuring a network adapter of a wireless camera system (e.g., wireless network adapter 208 of wireless camera system 202 in FIG. 2), in accordance with an embodiment of the invention. Mobile station 316 is one possible implementation of mobile station 116 of FIG. 1. The illustrated example of mobile station 316 includes user interface 302, microphone 310, and speaker 312. User interface 302 is shown as including user input fields 304 and 306, and a virtual button 308.

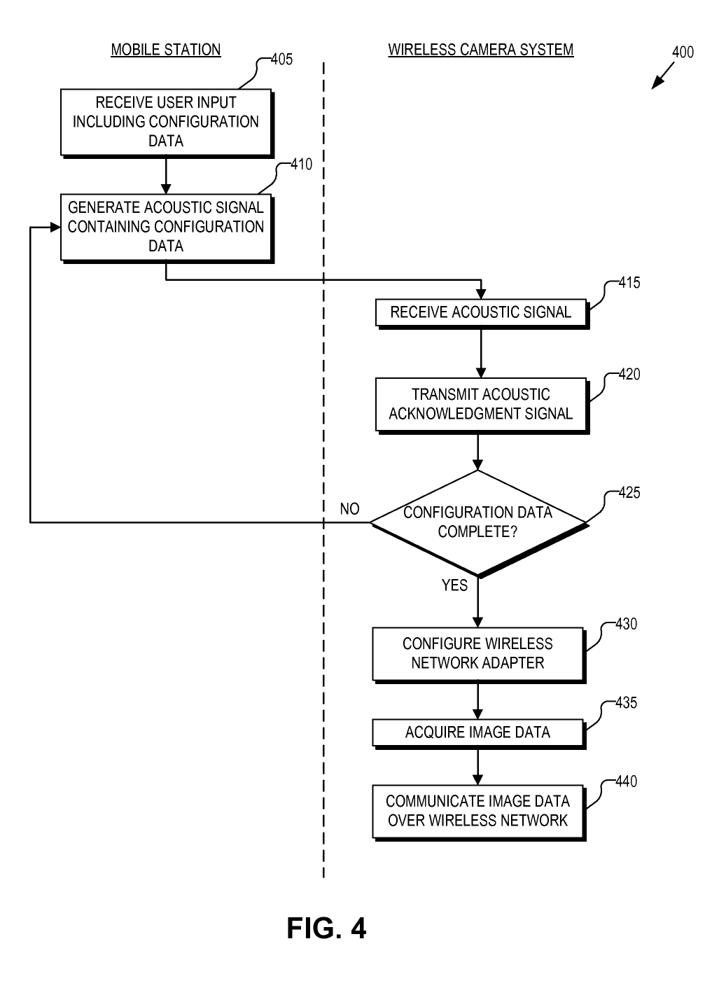

FIG. 4 is a flow diagram illustrating a process 400 of configuring a network adapter of a wireless camera system, in accordance with an embodiment of the invention. Process 400 will now be described with reference to FIGS. 2-4. In process block 405 mobile station 316 receives user input that includes configuration data. As shown in FIG. 3, user input may be received from a user (e.g., user 104) by way of user interface 302. As shown, user interface 302 may include user input fields for allowing the user to input various network parameters, such as SSID (i.e., user input field 304) and password (i.e., user input field 306). Although FIG. 3 illustrates user interface 302 as only including two user input fields (i.e., 304 and 306), other input fields may be included to allow the user to further configure the network adapter of the wireless camera system. For example, a user field may be presented on user interface 302 to allow the user to specify the encryption type (e.g., WEP, WPA, WPA2, etc.).

In process block 410, the user selects the virtual button 308 to have mobile station 316 generate acoustic signal 118 via speaker 312. As mentioned above, the acoustic signal contains the configuration data entered by the user. In one embodiment, acoustic signal 118 is a multi-frequency signal. That is, the multi-frequency signal may use a series of tones to represent letters, numbers, and/or various codes. For example, a 100 Hz frequency tone may represent the character “A”, while a 200 Hz tone represents the character “B”.

Next, in process block 415, wireless camera system 202 receives and detects acoustic signal 118 by way of acoustic receiver 214. In one embodiment, mobile station 316 transmits the configuration data in segments rather than all at once. Thus, once wireless camera system 202 receives a segment, acoustic transmitter 216 may generate and transmit acoustic acknowledgement signal 120 to acknowledge receipt of that segment of the configuration data (i.e., process block 420). By way of example, mobile station may sequentially transmit a sequence of acoustic signals representing “ABCD.” After mobile station 316 generates the tone associated with the character “A”, it then waits until it detects the corresponding acoustic acknowledgement signal 120 before generating the tone associated with the next character “B”, and so on. It is in this manner that a complete configuration data may be communicated acoustically from mobile station 316 to wireless camera system 202.

In decision block 425, if the configuration data is complete, process 400 continues on to process block 430. If not, process 400 returns to process block 410 to generate an acoustic signal for the next segment of the configuration data. In process block 430, processor 204 configures wireless network adapter 206 to communicate over the wireless network using the received configuration data. Next, in process block 435 camera 210 may begin acquiring image data and in process block 440, wireless network adapter 208 begins communicating the acquired image data over the wireless network.

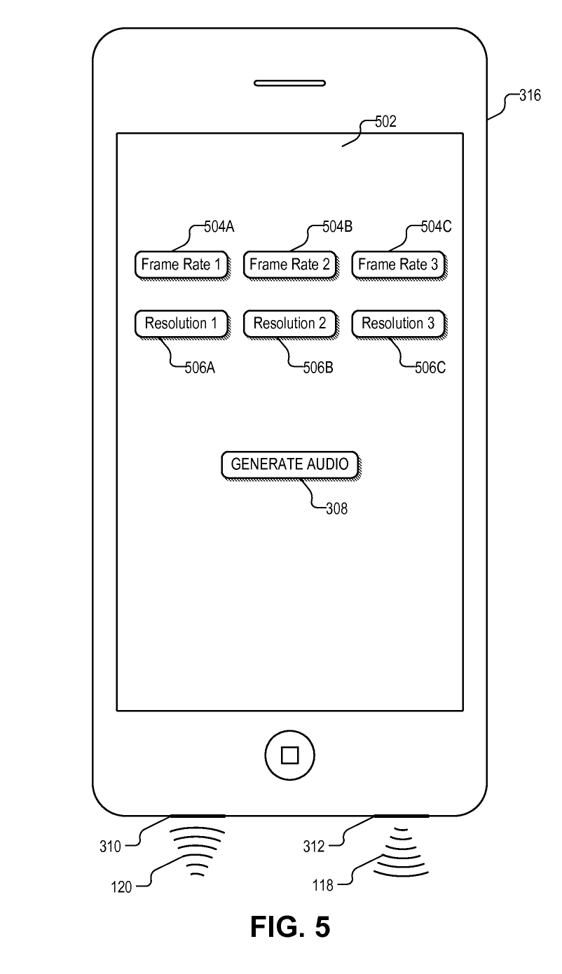

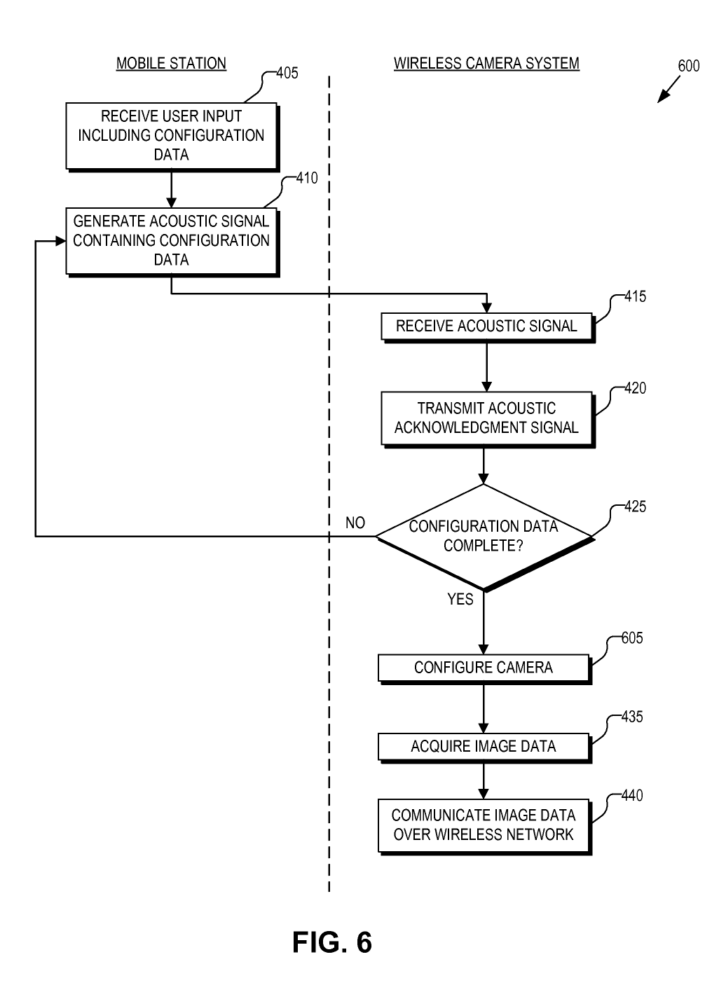

FIG. 5 illustrates a user interface 502 of a mobile station for configuring a camera of a wireless camera system (e.g., camera 210 of wireless camera system 202 in FIG. 2), in accordance with an embodiment of the invention. As mentioned above, in addition to the acoustic configuration of the wireless network adapter, embodiments of the present disclosure may also be applicable to the acoustic configuration of other aspects of the wireless camera system, as well. For example, user interface 502 may provide the user with the option of setting the frame rate (e.g., virtual buttons 504A-C) and resolution (e.g., virtual buttons 506A-C) of the camera included in the wireless camera system. FIG. 6 is a flow diagram illustrating a process 600 of configuring the camera of a wireless camera system, in accordance with an embodiment of the invention. Process 600 is similar to process 400 of FIG. 4, except instead of processor 204 configuring the wireless network adapter 208, process 600 includes process block 605 where processor 204 configures the camera 210 using the received configuration data of acoustic signal 120.

The order in which some or all of the process blocks appear in each process should not be deemed limiting. Rather, one of ordinary skill in the art having the benefit of the present disclosure will understand that some of the process blocks may be executed in a variety of orders not illustrated.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A wireless camera system, comprising:
a camera configured to acquire image data;
a wireless network adapter coupled to the camera for wirelessly communicating the image data over a wireless network;
an acoustic receiver configured to receive an acoustic signal containing configuration data; and
a processor coupled to the acoustic receiver to configure the network adapter to communicate over the wireless network using the received configuration data of the acoustic signal.

2. The wireless camera system of claim 1, wherein the acoustic signal is a multi-frequency (MF) signal.

3. The wireless camera system of claim 1, wherein the configuration data includes a service set identifier (SSID) of the wireless network.

4. The wireless camera system of claim 1, wherein the configuration data includes a password of the wireless network.

5. The wireless camera system of claim 1, further comprising an acoustic transmitter for transmitting an acoustic acknowledgment signal acknowledging receipt of the configuration data.

6. The wireless camera system of claim 5, wherein the acoustic transmitter includes a speaker.

7. The wireless camera system of claim 1, wherein the acoustic receiver includes a microphone.

8. The wireless camera system of claim 1, wherein the configuration data includes at least one parameter selected from the group consisting of camera frame rate and camera resolution, and wherein the processor is further coupled to configure the camera to acquire the image data using the at least one parameter.

9. A method of configuring a wireless camera system to communicate image data over a wireless network, the method comprising:
receiving an acoustic signal at the wireless camera system, the acoustic signal containing configuration data; and
configuring a wireless network adapter of the wireless camera system using the configuration data contained in the acoustic signal.

10. The method of claim 9, further comprising:
receiving user input at a mobile station, wherein the user input includes the configuration data for the wireless network; and
generating the acoustic signal that includes the configuration data with the mobile station.

11. The method of claim 9, wherein the acoustic signal is a multi-frequency (MF) signal.

12. The method of claim 9, wherein the configuration data includes a service set identifier (SSID) of the wireless network.

13. The method of claim 9, wherein the configuration data includes a password of the wireless network.

14. The method of claim 9, further comprising transmitting an acoustic acknowledgment signal acknowledging receipt of the configuration data.

15. The method of claim 14, wherein receiving the acoustic signal at the wireless camera system includes receiving a first acoustic signal that contains a first set of configuration data, the method further comprising receiving a second acoustic signal containing a second set of configuration data after transmitting the acoustic acknowledgment signal.

16. The method of claim 9, wherein the configuration data includes at least one parameter selected from the group consisting of camera frame rate and camera resolution, and wherein the method further comprises configuring a camera of the wireless camera system to acquire the image data using the at least one parameter.

17. A wireless camera system, comprising:
means for receiving an acoustic signal at the wireless camera system, the acoustic signal containing configuration data for communicating over a wireless network; and
means for configuring a wireless network adapter of the wireless camera system using the configuration data contained in the acoustic signal.

18. The wireless camera system of claim 17, wherein the acoustic signal is a multi-frequency (MF) signal.

19. The wireless camera system of claim 17, wherein the configuration data includes a service set identified (SSID) of the wireless network.

20. The wireless camera system of claim 17, wherein the configuration data includes a password of the wireless network.

21. The wireless camera system of claim 17, further comprising means for transmitting an acoustic acknowledgment signal acknowledging receipt of the configuration data.

22. The wireless camera system of claim 17, wherein the configuration data includes at least one parameter selected from the group consisting of camera frame rate and camera resolution, and wherein system further comprises means for configuring a camera of the wireless camera system to acquire the image data using the at least one parameter.
